(19) United States
(12) Patent Application Publication
(10) Pub. No.: US 2010/0057686 A1
(43) Pub. Date: Mar. 4, 2010

(54) Deep Web Search

(76) Inventors: Oded Haim Breiner, Netanya (IL); Doron Izhaki, Netanya (IL); Shlomit Zairi, Even Yehuda (IL)

Correspondence Address: The Law Office of Michael E. Kondoudis, 888 16th Street, N.W., Suite 800, Washington, DC, 20006, US

(21) Appl. No.: 12/203,593

(22) Filed: Sep. 3, 2008

(51) Int. Cl. G06F 7/06; G06F 17/30

(52) U.S. Cl. 707/3; 707/E17.108

(57) ABSTRACT

A data processing system and a computer implemented method for searching registered websites including multimedia content according to a user query. The data processing system includes a mediator server with a database storing the multimedia content from the registered websites and an application configured to receive and apply the user's query to the database and provide search results at least one resolution. The computer implemented method includes: (i) receiving multimedia content of the registered websites and storing the content in a database, (ii) receiving and applying the user's query, and (iv) providing search results at least one resolution.

### FIELD OF THE INVENTION

The present invention generally relates to the field of Internet. More particularly, the present invention relates to search and indexing methods.

### BACKGROUND OF THE INVENTION

A large portion of Internet content is unsearchable due to access limitation or other limitations. This portion is denoted as Deep Web. Also known as Dark Web and the Invisible Web.

U.S. Pat. No. 6,278,993, which is incorporated herein by reference in its entirety, discloses a method and apparatus for extending an on-line Internet search beyond pre-referenced sources and returning data over a data-packet-network (DPN) using private search engines as proxy-engines.

US Patent Publication No. 2006/0230033, which is incorporated herein by reference in its entirety, discloses a method of searching through content which is accessible through web-based form and a system that facilitates searching through content which is accessible through web-based forms. During operation, the system receives a query containing keywords. Next, the system analyzes the query to create a structured query. The system then performs a lookup based on the structured query in a database containing entries describing the web-based forms. Next, the system ranks forms returned by the lookup, and uses the rankings and associated database entries to facilitate a search through content which is accessible through the forms.

### BRIEF SUMMARY

The present invention includes a data processing system and a computer implemented method for searching websites comprising multimedia content that are registered within the proposed service, in accordance with user defined query. One data processing system comprises a mediator server comprising a database storing indexed multimedia content from the registered websites and an application configured to receive and apply the user's query to the database and provide search results at least one resolution. One computer implemented method comprises (i) retrieving multimedia content of the registered websites and storing the content in a database, (ii) indexing the retrieved multimedia content from the registered websites, (iii) applying the user's query, and (iv) providing search results at least one resolution.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings (Figures, or simply “FIGS.”), wherein:

FIG. 1 is a block diagram illustrating a data processing system for searching registered websites comprising multimedia content according to a user query from a user, according to some embodiments of the invention;

FIG. 2 is a flowchart illustrating a computer implemented method of searching registered websites comprising multimedia content according to a user query, according to some embodiments of the invention; and

FIGS. 3A and 3B are flowcharts illustrating a computer implemented method of searching registered websites comprising multimedia content according to a user query, according to some embodiments of the invention.

FIG. 4 is a flowchart illustrating a computer implemented method of engaging content providers with a deep web search engine, according to a user query, according to some embodiments of the invention.

### DETAILED DESCRIPTIONS OF SOME EMBODIMENTS OF THE INVENTION

The present invention includes a data processing system and a computer implemented method for searching registered websites according to a user query received from a search engine.

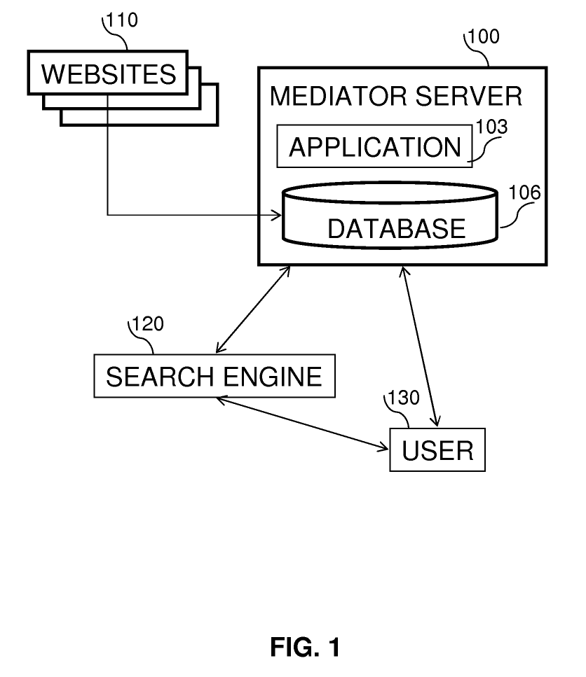

FIG. 1 is a block diagram illustrating a data processing system for searching registered websites 110 comprising multimedia content according to a user query from a user 130 according to some embodiments of the invention. The data processing system comprises a mediator server 100 that comprises a database 106 storing the multimedia content from registered websites 110, and an application 103 configured to receive and apply the user's query on database 106 and provide search results to user 130 at different resolutions, such as indicating on the existence of relevant searched information corresponding to the query in a website 110 or retrieving specific search results. Mediator server 100 may stand alone or be associated with a search engine 120, which may provide user 130 further results relating to the query. The query may be received at either mediator server 100 or search engine 120, and either of them may supply the main results.

According to some embodiments of the invention, mediator server 100 may provide user 130 with search results at different resolutions. For example a free service may indicate the existence of search results in website 110, whereas a paid-for service may provide the webpages in which the query terms appear. A premium service may allow searching for query terms at predefined parts of the web page.

According to some embodiments of the invention, the invention allows content providers such as websites 110 to engage with search engines supported by mediator server 100. Websites 110 allow mediator server 100 to index the content and supply it as search results, prompting user registration to websites 110. Search results may depend on user registration to either mediator server 100 or website 110, or both.

According to some embodiments of the invention, mediator server 100 may propose registration to the search engine to websites 110. Registration may determine the level of cooperation and exchange of information as well as exchange modes between mediator server 100 and websites 110. Additionally, the websites may determine the level of information exchange between the mediator server and the users (also referred to as: “resolution”).

According to some embodiments of the invention, mediator server 100 may be part of website 110 and be applied internally within website 110 to supply search abilities to users inside an organization or a community, e.g. registered users of website 110.

According to some embodiments of the invention, the search of websites 110 by mediator server 100 may be complementary to a search by a search engine 120, or may suggest search engine 120 as a complementary search to user 130.

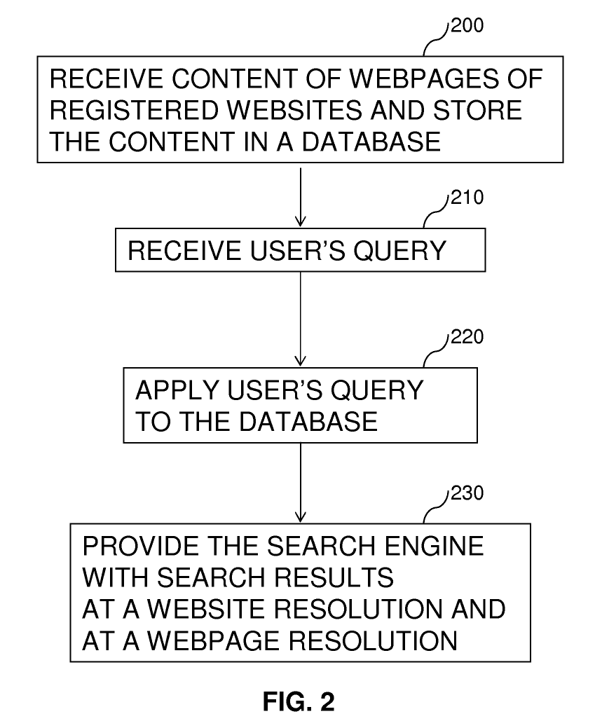

FIG. 2 is a flowchart illustrating a computer implemented method of searching registered websites comprising multimedia content according to a user query, according to some embodiments of the invention. The method may comprise the following stages:
retrieving the multimedia content of the registered websites and storing the content in a database (stage 200);
receiving (stage 210) and applying (stage 220) the user's query. Receiving the user's query (stage 210) may be directly from the user, or via a search engine; and providing search results at least one resolution (stage 230), e.g. at a website resolution (not detailed, occurrence within site) and at a webpage resolution (exact, as a premium service). Providing search results (stage 230) may be either directly to the user, via a search engine, or include references to other search engine as providers of additional results.

According to some embodiments of the invention, retrieving the multimedia content of the registered websites is preceded by a registration process.

According to some embodiments of the invention, multimedia content may comprises webpages.

According to some embodiments of the invention, providing search results at least one resolution (stage 230) may comprise providing search results at a domain level (existence of results within the domain), at a page title level (existence of results within the page title) and at a text level (existence of results within the text). Different resolutions may be related to different pricing for the user.

According to some embodiments of the invention, the method further comprises updating the database at predefined intervals, prompted by wither search engine or content provider (i.e. per push, pull or combination thereof).

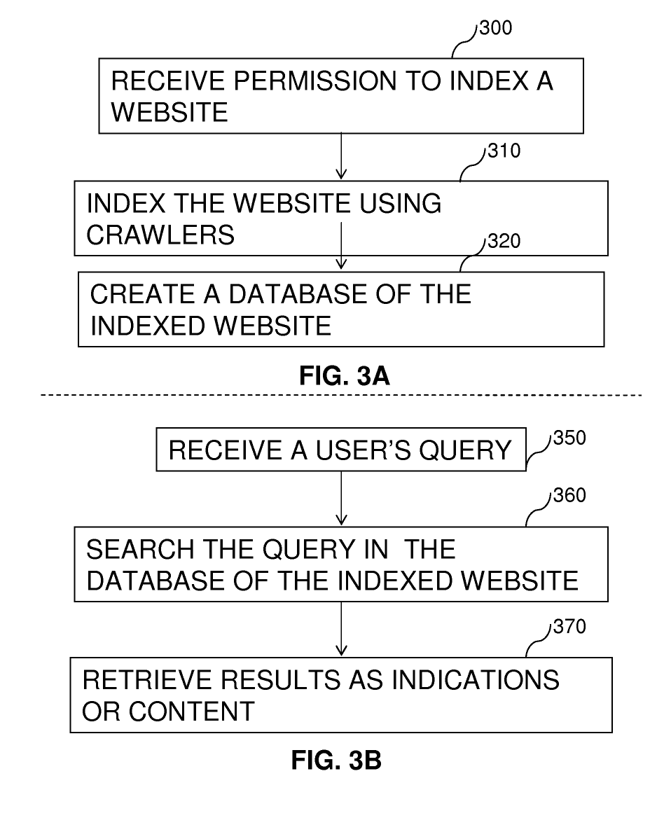

FIGS. 3A and 3B are flowcharts illustrating a computer implemented method of searching registered websites according to a user query, according to some embodiments of the invention. FIG. 3A illustrates stages of constructing a data base, FIG. 3B illustrates stages of data retrieval. The computer implemented method may comprise the following stages:
constructing a data base, comprising the stages:
   receiving permission to index a website (stage 300). The website may allow a mediator server to access its websites and use the information to enable searches in the website. Specifically it may provide access to content that is otherwise barred from regular crawlers by different means, such as private sites or limited access content (protected e.g. by passwords, captchas etc.);
   indexing the website using crawlers (stage 310); and
   creating a database of the indexed website (stage 320).
retrieving data relating to a user's query, comprising the stages:
   receiving a user's query (stage 350);
   searching the query in the database of the indexed website (stage 360); and
   retrieving results as indications or content (stage 370). Results may be retrieved as an indication (e.g. there are results in the site), or as content (e.g. specific webpages). Different variants may relate to the extent of use of the search engine, subscription to the search engine, subscription to the website etc.

According to some embodiments of the invention, the method be carried out independently of other search engines, may refer to other search engines to complete the search or may be referred to from other search engines as search extending means.

According to some embodiments of the invention, the method may further comprise the stages of finding websites that comprise protected content and proposing them to use the computer implemented method to index and allow search in the website. The website may condition the retrieval of search results in registration to the website.

According to some embodiments of the invention, retrieving results (stage 370) and their extent may depend on user registration to the website (e.g. registered user may receive content while unregistered users may only receive an indication that the content exists).

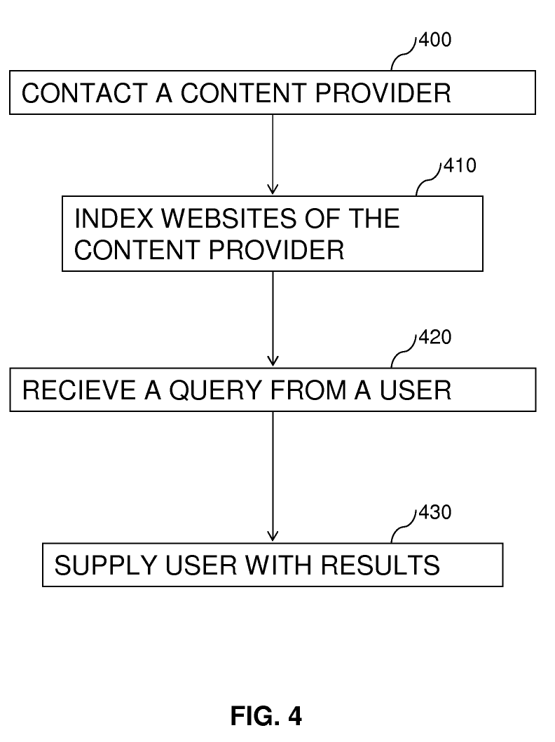

FIG. 4 is a flowchart illustrating a computer implemented method of engaging content providers with a deep web search engine, according to a user query, according to some embodiments of the invention. The computer implemented method may comprise the following stages:
contacting a content provider by a deep web search engine provider (stage 400).
An agreement is reached relating the extent of content made available for indexing, levels of detail in which search results are supplied to users, dependency of search result supply upon registration and technical details;
indexing websites of the content provider (stage 410) to a database by crawlers of the deep web search engine provider;
receiving a query from a user (stage 420); and
supplying user with results (stage 430) according to the terms agreed upon with the content provider, suggesting registration, etc.

According to some embodiments of the invention, the method may be applied internally within a website to supply search abilities to users inside an organization or a community.

According to some embodiments of the invention, advantages of the disclosed data processing system and computer implemented methods are extending search possibilities for users, adding registered users to websites and supplying a domain specific search tool.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

For example, methods may be executed according to instructions stored in a tangible computer-readable storage medium or memory.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A data processing system for searching at least one registered website comprising multimedia content according to a user query, the data processing system comprising
a mediator server comprising:
a database arranged to store the multimedia content from the at least one registered website; and
an application configured to receive and apply the user's query to the database and provide search results at least one resolution.

2. The data processing system of claim 1, wherein the mediator server is embedded in the at least one registered website and is applied internally to supply search abilities to registered users of the at least one registered website.

3. The data processing system of claim 1, wherein the database is arranged to store the multimedia content in different extents relating to indexing availability.

4. The data processing system of claim 1, wherein the application is arranged to provide the search results in an at least one of: a domain level resolution; a page title level resolution; and a text level resolution.

5. The data processing system of claim 1, wherein the at least one resolution is related to user registration.

6. The data processing system of claim 1, wherein the multimedia content comprises webpages.

7. A computer implemented method of searching registered websites comprising multimedia content according to a user query, the computer implemented method comprising:
receiving the multimedia content of the registered websites and storing the multimedia content in a database;
receiving and applying the user query; and
providing search results at least one resolution.

8. The computer implemented method of claim 7, further comprising updating the database at predefined intervals.

9. The computer implemented method of claim 7, further comprising contacting a provider of the registered websites and agreeing upon at least one of the following: an extent of content made available for indexing; levels of detail in which search results are supplied to users; a dependency of search result supply upon registration; and technical details.

10. The computer implemented method of claim 7, wherein the at least one resolution comprises at least one of: a domain level resolution; a page title level resolution;
and a text level resolution.

11. The computer implemented method of claim 7, wherein different resolutions of the search results are related to different pricings for the user.

12. The computer implemented method of claim 7, wherein retrieving the multimedia content of the registered websites is preceded by a registration process.

13. The computer implemented method of claim 7, wherein the multimedia content comprises webpages.

14. A computer-readable storage medium encoded with processing instructions that cause a processor to execute a method of searching registered websites comprising multimedia content according to a user query, the method comprising
receiving the multimedia content of the registered websites and storing the multimedia content in a database;
receiving and applying the user query; and
providing search results at least one resolution.

15. The medium of claim 15, wherein the applying the user inquiry may be complementary to a search by a search engine or may suggest a search engine as a complementary search to a user.
